(19) United States
(12) Patent Application Publication
(10) Pub. No.: US 2021/0300437 A1
(43) Pub. Date: Sep. 30, 2021

(54) MANAGEMENT DEVICE, MANAGEMENT METHOD, AND PROGRAM

(71) Applicant: HONDA MOTOR CO., LTD., Tokyo (JP)

(72) Inventors: Yusuke Kawada, Wako-shi (JP); Kensaku Yamamoto, Wako-shi (JP); Yurie Kondo, Tokyo (JP); Ryohei Iwaki, Wako-shi (JP); Toshikatsu Kuramochi, Tokyo (JP)

(21) Appl. No.: 17/208,009

(22) Filed: Mar. 22, 2021

(30) Foreign Application Priority Data
Mar. 31, 2020 (JP) 2020-064883

(51) Int. Cl. B60W 60/00; G05B 13/02; G07C 5/00; G06Q 20/14; G05D 1/02

(52) U.S. Cl. CPC B60W 60/00256; G05B 13/0265; G05D 2201/0213; G06Q 20/145; G05D 1/0214; G07C 5/008

(57) ABSTRACT

A management device manages an operation of a load-carrying vehicle which autonomously travels on a road with no driver on board and in which each of a plurality of storage parts shielded using a door which is opened and closed is able to store a load. The management device includes: an operation determination unit configured to decide an operation of the load-carrying vehicle; and an assignment determination unit configured to decide assignment of the load to any of the plurality of storage parts. When a type of new load to be collected is a prescribed type, the assignment determination unit makes a decision so that the new load to be collected is caused to be carried in a manner in which the load does not easily receive an influence from outside as compared with other types of loads.

### CROSS-REFERENCE TO RELATED APPLICATION

Priority is claimed on Japanese Patent Application No. 2020-064883, filed on Mar. 31, 2020, the contents of which are incorporated herein by reference.

### BACKGROUND

### Field of the Invention

The present invention relates to a management device, a management method, and a program.

### Background

An invention relating to an autonomous mobile device which can move autonomously and an automated delivery system which delivers a load using a server system operating in conjunction with the autonomous mobile device has been disclosed (refer to Japanese Unexamined Patent Application, First Publication No. 2018-058656).

### SUMMARY

The related art described above has not been able to carry a load in a manner suitable for a type of load.

An object of an aspect of the present invention is to provide a management device, a management method, and a program which can cause a load to be carried in accordance with a manner suitable for a type of the load.

A first aspect of the present invention is a management device which manages an operation of a load-carrying vehicle which autonomously travels on a road with no driver on board and in which each of a plurality of storage parts shielded using a door which is opened and closed is able to store a load, the management device including: an operation determination unit configured to decide an operation of the load-carrying vehicle; and an assignment determination unit configured to decide assignment of the load to any of the plurality of storage parts, wherein, when a type of new load to be collected is a prescribed type, the assignment determination unit makes a decision so that the new load to be collected is caused to be carried in a manner in which the load does not easily receive an influence from outside as compared with other types of loads.

In a second aspect of the present invention, in the management device according to the first aspect, when the type of new load to be collected is a prescribed type, the assignment determination unit may make a decision so that a low impact storage part of the plurality of storage parts in which a load to be stored does not easily receive an influence of an impact from outside as compared with other storage parts stores the load, and the operation determination unit may instruct a drive part of the door corresponding to the low impact storage part decided using the assignment determination unit to load the new load to be collected.

In a third aspect of the present invention, in the management device according to the second aspect, the low impact storage part may be a storage part provided at a center of the plurality of storage parts.

In a fourth aspect of the present invention, in the management device according to the second or third aspect, a suspension configured to reduce an influence of an impact from outside on a load to be stored may be provided outside the low impact storage part.

In a fifth aspect of the present invention, in the management device according to any one of the second to fourth aspects, a cushioning material configured to reduce an influence of an impact from outside on a load to be stored may be provided inside the low impact storage part.

In a sixth aspect of the present invention, in the management device according to any one of the first to fifth aspects, when the type of new load to be collected is a prescribed type, the operation determination unit may make a decision so that the load-carrying vehicle is caused to travel on a route in which the load to be stored does not easily receive an influence of an impact from outside as compared with other carrying routes.

In a seventh aspect of the present invention, in the management device according to any one of the first to sixth aspects, when the type of new load to be collected is a prescribed type, the operation determination unit may make a decision so that the load-carrying vehicle is caused to travel at a speed lower than that in a case in which other types of loads are carried.

In an eighth aspect, in the management device according to any one of the first to seventh aspects, the management device may further include: a payment processor configured to perform processing of collecting a usage fee from a user of a load-carrying service in which the load-carrying vehicle is used, wherein, when a decision has been made so that the new load to be collected is caused to be carried in a manner in which the load does not easily receive an influence of an impact from outside, the payment processor may collect a usage fee higher than that in a case in which a decision has been made so that the new load to be collected is caused to be carried in a manner other than a manner in which the new load to be collected does not easily receive an influence from outside.

In a ninth aspect of the present invention, in the management device according to any one of the first to eighth aspects, a cushioning material configured to reduce an influence of an impact from outside on a load to be stored may be provided on a side surface of each of the plurality of storage parts.

A tenth aspect of the present invention is a management method in which a computer for a management device which manages an operation of a load-carrying vehicle which autonomously travels on a road with no driver on board and in which each of a plurality of storage parts shielded using a door which is opened and closed is able to store a load is utilized, the management method including: deciding an operation of the load-carrying vehicle; deciding assignment of the load to any of the plurality of storage parts; and making, when a type of new load to be collected is a prescribed type, a decision so that the new load to be collected is caused to be carried in a manner in which the new load to be collected does not easily receive an influence from outside as compared with other types of loads.

An eleventh aspect of the present invention is a computer-readable non-transitory medium which includes a program causing a computer for a management device which manages an operation of a load-carrying vehicle which autonomously travels on a road with no driver on board and in which each of a plurality of storage parts shielded using a door which is opened and closed is able to store a load: to decide an operation of the load-carrying vehicle; to decide assignment of the load to any of the plurality of storage parts; and to make, when a type of new load to be collected is a prescribed type, a decision so that the new load to be collected is caused to be carried in a manner in which the new load to be collected does not easily receive an influence from outside as compared with other types of loads.

According to the first to eleventh aspects described above, it is possible to cause a load to be carried in accordance with a manner suitable for a type of the load.

### BRIEF DESCRIPTION OF THE DRAWINGS

FIG. 1 is a diagram illustrating a constitution of a carrying system including a management device.

FIG. 2 is a diagram illustrating a constitution of a load-carrying vehicle.

FIG. 3 is a diagram illustrating an example of a structure relating to a plurality of storage parts.

FIG. 4 is a diagram illustrating an example of a position in which a low impact storage part is arranged.

FIG. 5 is a diagram illustrating an example of an internal structure of the low impact storage part.

FIG. 6 is a diagram illustrating an example of an airbag provided on a storage part.

FIG. 7 is a diagram illustrating a constitution of the management device.

FIG. 8 is a diagram illustrating an example of the details of user information.

FIG. 9 is a diagram illustrating an example of a carrying service application screen configured to input application information displayed on a display of a terminal device.

FIG. 10 is a diagram illustrating an example of the details of an application information list.

FIG. 11 is a diagram illustrating an example of the details of movement schedule information.

FIG. 12 is a diagram illustrating an example of the details of payment information.

FIG. 13 is a diagram illustrating an example of a scene having option 2 selected therein.

FIG. 14 is a diagram illustrating an example of a scene having option 4 selected therein.

FIG. 15 is a diagram illustrating an example of a state of the load-carrying vehicle when the option 4 is selected.

FIG. 16 is a diagram illustrating an example of a state of the load-carrying vehicle when option 5 is selected.

FIG. 17 is a flowchart describing an example of processing of assigning a low impact storage part.

FIG. 18 is a flowchart describing an example of processing of an airbag controller.

FIG. 19 is a flowchart describing an example of processing of a monitor.

### DESCRIPTION OF EMBODIMENTS

Embodiments of a management device, a management method, and a program of the present invention will be described below with reference to the drawings. A load-carrying vehicle managed by the management device can autonomously travel on a road with no driver on board and includes a load storage part shielded using a door which can be opened and closed.

Each load-carrying vehicle recognizes the situation outside the vehicle using monitoring units such as cameras, radar devices, and a light detection and ranging (LiDAR) device and, in principle, moves on a road to avoid obstacles upon the road while traveling on a route instructed through the management device. The load-carrying vehicle moves on a road at a speed of about 10 [km] by driving the wheels thereof, for example, using a motor. A storage part unit of the load-carrying vehicle has, for example, a plurality of spaces (storage parts) formed therein used for carrying a load partitioned from other spaces and is configured so that a plurality of users can have loads carried therein (loaded thereinto).

The management device manages (controls) an operation of the load-carrying vehicle. The management device may be a device placed in a place different from that of the load-carrying vehicle, and may communicate with the load-carrying vehicle over a network, or a device in which some or all functions thereof are installed in the load-carrying vehicle. The management device generates, for example, movement schedule information on the basis of application information acquired through communication from a user's terminal device. Moreover, the management device instructs the load-carrying vehicle with respect to a route or a stop location of the load-carrying vehicle, an open/closed state of the door of each of the storage parts, and the like on the basis of the movement schedule information.

In the following description, it is assumed that the management device is a device placed in a place different from that of the load-carrying vehicle (for example, a device in a form called a cloud server) and realizes the above functions through communication with the user's terminal device or the load-carrying vehicle over the network.

<Embodiment>

### [Overall Constitution]

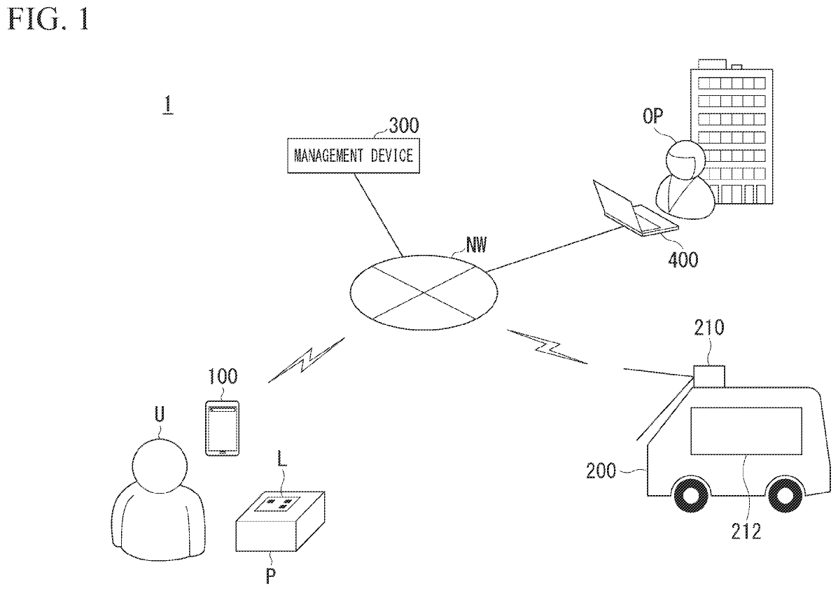

FIG. 1 is a diagram illustrating a constitution of a carrying system 1 including a management device 300. The carrying system 1 includes one or more load-carrying vehicles 200, the management device 300, and an operator device 400 used by an operator OP. The management device 300 communicates with a terminal device 100 used by a user U over a network NW. The network NW includes the Internet, wide area networks (WANs), local area networks (LANs), public circuits, provider devices, dedicated circuits, wireless base stations, and the like. Furthermore, the management device 300 communicates with the load-carrying vehicles 200 and the operator device 400 over the network NW. The “terminal device used by a user” may be a terminal device which can be used by an unspecific number of people, such as terminal devices in Internet cafes, and includes terminal devices temporarily used by the user U. In any case, the “user's terminal device” refers to a terminal device specifically identified by the user U during an operation through, for example, a login operation in which a login name is input.

The user U transmits application information used for requesting the carrying of a load P to the management device 300 using the terminal device 100. The load P has identification information of the load P and/or the user U written thereon or a label L stored in an IC tag or the like which is built thereinto provided therein. The expression “provided therein” means, for example, adhered using a sticker.

The terminal device 100 is, for example, a smartphone, a tablet terminal, a personal computer, or the like. The terminal device 100 starts up an application program, a browser, or the like configured to use the above service (hereinafter referred to as a “carrying service”) and supports the carrying service. In the following description, it is assumed that the terminal device 100 is a smartphone and an application program configured to receive the carrying service (a carrying service application) starts up. The carrying service application communicates with the management device 300 in accordance with a user's operation and transmits application information from the user to the management device 300 or provides information based on the information received from the management device 300. The application information is electronic information which requests the load-carrying vehicles 200 to carry the load P over a designated section. [Load-Carrying Vehicle]

Each of the load-carrying vehicles 200 includes a monitoring unit 210, such as a camera, a radar device, and a LiDAR, and autonomously travels on a road as described above. A display device 212 may be provided in the load-carrying vehicle 200. The display device 212 may have a touch panel function or may have an embedded function for communicating with a non-contact type IC card.

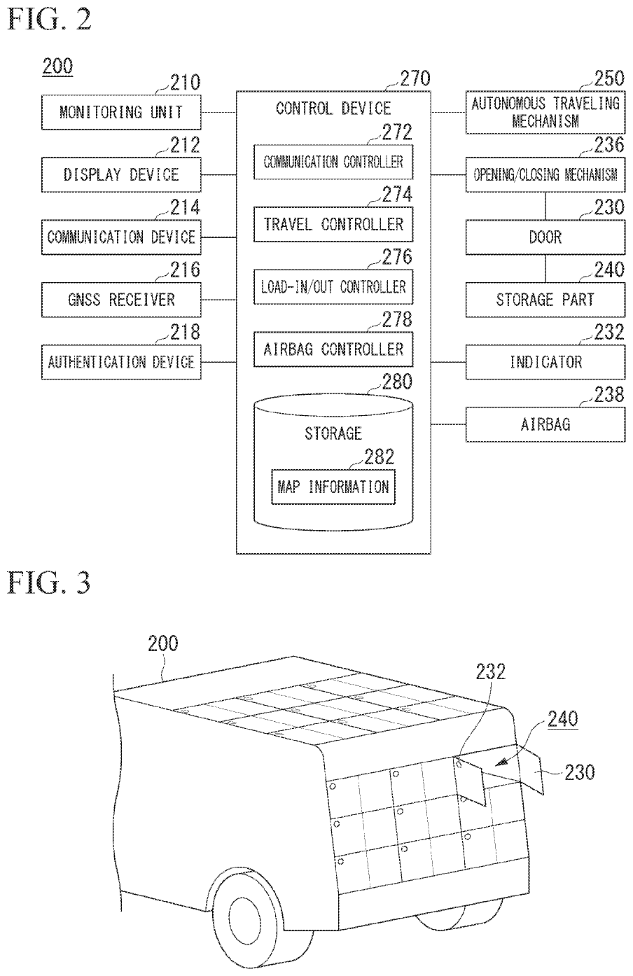

FIG. 2 is a diagram illustrating a constitution of the load-carrying vehicles 200. The load-carrying vehicle 200 includes a communication device 214, a GNSS receiver 216, an authentication device 218, an opening/closing mechanism 236, an airbag 238, an autonomous traveling mechanism 250, and a control device 270, in addition to the monitoring unit 210 and the display device 212 described above.

The communication device 214 is, for example, a wireless communication module configured to perform connection to the network NW or directly communicate with a terminal device or the like of another vehicle or a pedestrian. The communication device 214 performs wireless communication on the basis of Wi-Fi, dedicated short-range communications (DSRCs), Bluetooth (registered trademark), and other communication standards. As the communication device 214, a plurality of communication devices may be prepared in accordance with the intended use.

The GNSS receiver 216 positions a position of the device itself (a position of the load-carrying vehicle 200) on the basis of radio waves arriving from GNSS satellites (for example, GPS satellites). The GNSS receiver 216 outputs the positioning result to the control device 270.

The authentication device 218 is a device configured to confirm that the user U who attempts to load the load P into the load-carrying vehicles 200 is a legitimate user U (configured to authenticate the user U). The legitimate user U means a user U for which an arrangement (reservation) regarding the carrying of a load has been provided from the management device 300. The authentication device 218 may be any device as long as it has an authentication function, such as a short-range wireless communication device, a biometric authentication device, and a password input device. The authentication device 218 outputs the authentication result to the control device 270.

The opening/closing mechanism 236 is provided for each door 230 and includes a motor, an arm, and the like. The opening/closing mechanism 236 opens/closes the doors 230 individually. For example, a switch configured to detect that the door 230 has been manually closed is attached to the door 230. A locking mechanism may be provided in place of (or in addition to) the opening/closing mechanism 236. In this case, a door of a storage part 240 used by the user U is unlocked, an indicator 232 (which will be described later) lights up, and the user U manually opens and closes the door 230.

The airbag 238 is provided on a surface (in this case, an upper surface or a back surface) of the storage part 240 included in the load-carrying vehicle 200. The details of the airbag 238 will be given later.

FIG. 3 is a diagram illustrating an example of a structure relating to a plurality of storages 240. The load-carrying vehicle 200 includes the plurality of storages 240. In the illustrated constitution, nine storage parts 240 which open on the upper surface side of the load-carrying vehicle 200 and nine storage parts 240 which open on the back surface side thereof are provided in the load-carrying vehicle 200. The door 230 is provided in each of the storages 240. The door 230 opens and closes, for example, in the form of double doors (hinged double doors) and exposes at least a part of the storage part 240 in an open state. The indicator 232 is attached to correspond to one of the storages 240 (for example, on a surface side of each of the doors 230).

The indicator 232 consists of, for example, a light-emitting diode (LED). The indicator 232 is caused to emit light using a load-in/out controller 276 which will be described later to indicate a load-in position of the load P to be loaded in or a position in which the load P to be unloaded is stored. One load P or a load P of one user U is arranged to be stored in each of the storages 240. For example, at a collection center, for the load P stored in the storage part 240, a user associated with the load P is recognized on the basis of the details of the storage part 240 in which the load is stored. Moreover, for example, when a worker at a collection center applies a label to the load P, a delivery destination (a load-out point) can be specifically identified in the subsequent work.

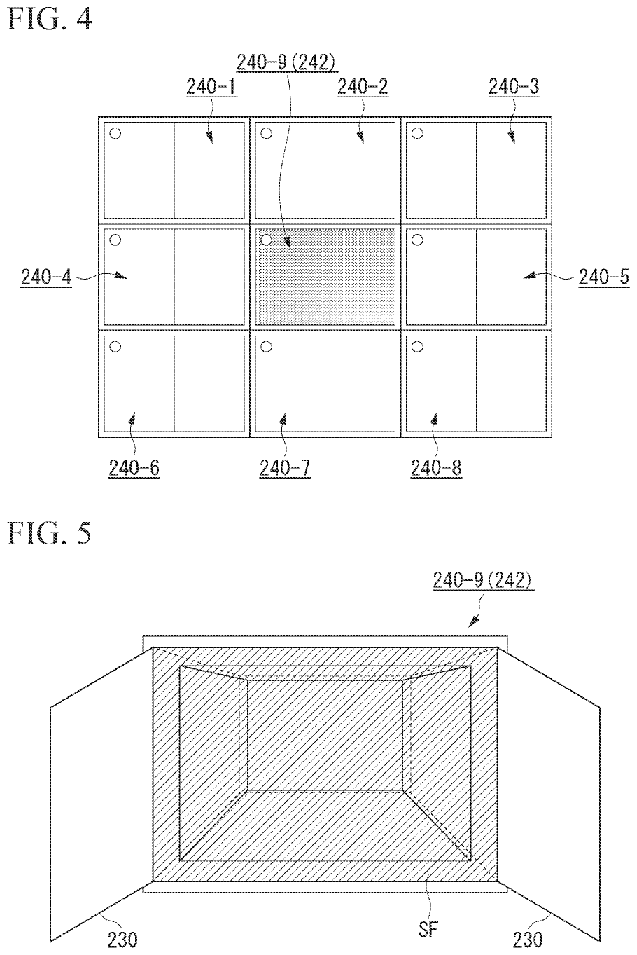

FIG. 4 is a diagram illustrating an example of a position in which a low impact storage part 242 is arranged. FIG. 4 is a diagram of the nine storage parts 240 which open on the back surface side or on the upper surface side when viewed from the front. As described above, the nine storage parts 240, such as storages 240-1 to 240-9, are provided in each of the back surface and the upper surface of the load-carrying vehicle 200. Here, the storage part 240-9 of the storage parts 240-1 to 240-9 is the low impact storage part 242. When the low impact storage part 242 is provided at a center of the plurality of storage parts 240, the storage part 240 does not easily receive an impact compared with the other storages 240-1 to 240-8. In the following description, when the storages 240-1 to 240-9 and the low impact storage part 242 are not distinguished from each other, they are simply referred to as a “storage part 240”.

FIG. 5 is a diagram illustrating an example of an internal structure of the low impact storage part 242. A cushioning material SF configured to reduce an impact from the outside on a load P to be stored is provided inside the low impact storage part 242. In FIG. 5, the cushioning material SF is provided on at least five surfaces (excluding a surface formed by the door 230) of six surfaces forming an inner surface of the low impact storage part 242. Thus, in the low impact storage part 242, the load P stored in the low impact storage part 242 cannot easily receive an impact from the outside compared with the other of the storages 240.

In the low impact storage part 242, the cushioning material SF may also be provided on an inner surface of the door 230. Furthermore, a suspension (not shown) configured to reduce an influence of an impact from the outside on a load P to be stored instead of (or in addition to) a constitution in which the cushioning material SF is provided inside may be provided. For example, in the low impact storage part 242, the suspension may be provided between the low impact storage part 242 and the neighboring storages 240 (in this case, the storage parts 240-2, 240-4, 240-5, and 240-7). Thus, a load P to be stored in the low impact storage part 242 cannot easily receive an impact from the outside compared with the other storages 240.

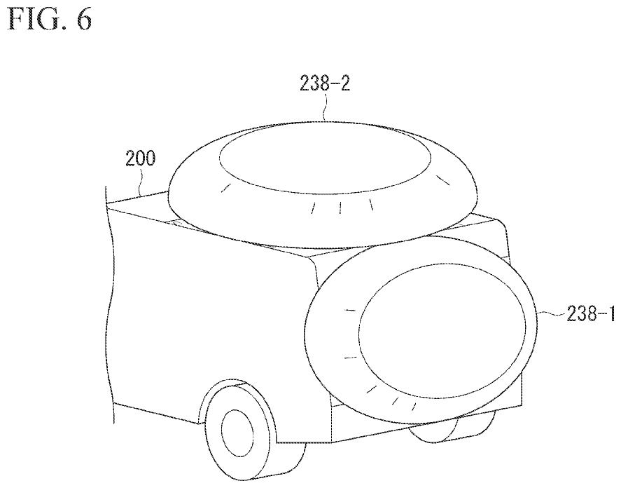

FIG. 6 is a diagram illustrating an example of the airbag 238 provided in the storage part 240. In the load-carrying vehicle 200, an airbag 238-1 is provided on the upper surface side of the load-carrying vehicle 200 and an airbag 238-2 is provided on the back surface side of the load-carrying vehicle 200. In the following description, when the airbag 238-1 and the airbag 238-2 are not distinguished from each other, they are simply referred to as an “airbag 238”. The control device 270 causes the airbag 238 to inflate when the monitoring unit 210 detects that an object has collided with the load-carrying vehicle 200 or that an object is likely to collide with the load-carrying vehicle 200. The airbag 238 inflates on the basis of the control of the control device 270 and reduces an influence of an impact from the outside on a load to be stored. The airbag 238 is an example of a “cushioning material”. Thus, a load P to be stored in the low impact storage part 242 cannot easily receive an impact from the outside.

The load-carrying vehicle 200 may include airbags 238 provided in each of the storages 240 instead of (or in addition to) a constitution in which the airbag 238 is provided for each surface on which the storage part 240 is provided. In this case, the control device 270 specifically identifies a location of the load-carrying vehicle 200 which has collided (or will collide) with an object on the basis of the detection result of the monitoring unit 210.

The control device 270 causes the airbag 238 to inflate at a location according to the specifically identified location. For example, when it is detected that an object has collided (or will collide) with the load-carrying vehicle 200 from a right side surface thereof, the control device 270 causes the airbag 238 of the storages 240-1 to 240-9 provided on the back surface corresponding to the storages 240-3, 240-5, and 240-8 located on the right side of the load-carrying vehicle 200 to inflate.

Also, the load-carrying vehicle 200 may have a function of (automatically) storing an inflated airbag 238. A case in which the load-carrying vehicle 200 has a function of storing the inflated airbag 238 will be described below. In this case, even if an event in which the airbag 238 is caused to inflate occurs, when there is no problem when the load-carrying vehicle 200 travels after the event, or the like, the load-carrying vehicle 200 can store the airbag 238 and continuously perform the carrying service on the basis of an instruction of the management device 300.

Referring to FIG. 2 again, the autonomous traveling mechanism 250 includes a driving force source, such as wheels and a motor, an energy accumulation means, such as batteries, a steering mechanism, and the like. The autonomous traveling mechanism 250 moves the load-carrying vehicle 200 in an arbitrary direction in response to an instruction from the control device 270.

The control device 270 includes, for example, a communication controller 272, a travel controller 274, the load-in/out controller 276, and an airbag controller 278. These constituent elements are realized using, for example, a program (software) executed by a hardware processor, such as a central processing unit (CPU). Some or all of these constituent elements may be realized using hardware (circuits; including a circuitry), such as a large-scale integration (LSI), an application-specific integrated circuit (ASIC), a field-programmable gate array (FPGA), and a graphics-processing unit (GPU) or may be realized in cooperation with software and hardware. The program may be stored in advance in a storage device (a storage device including a non-transient storage medium), such as a hard disk drive (HDD) or a flash memory, may be stored in a removable storage medium (a non-transient storage medium), such as a DVD or a CD-ROM, and may be installed in a storage device when a storage medium is installed in a drive device. The control device 270 includes a storage 280 having map information 282 stored therein. The storage 280 is an HDD, a flash memory, a ROM, a random-access memory (RAM), or the like.

The communication controller 272 acquires route information from the management device 300 via the communication device 214 and outputs the acquired route information to the travel controller 274. The communication controller 272 uploads position information indicating a position positioned through the GNSS receiver 216 using the communication device 214 to the management device 300. The position information is uploaded periodically, for example, in milliseconds to seconds.

The travel controller 274 controls the autonomous traveling mechanism 250 so that the load-carrying vehicle 200 travels on the route designated using the management device 300. For example, the travel controller 274 matches the route acquired from the management device 300 with the map information 282 and an output of the monitoring unit 210 and decides a detailed route along which the load-carrying vehicle 200 needs to travel. The travel controller 274, in principle, travels on a route and causes the load-carrying vehicle 200 to autonomously travel so that the load-carrying vehicle 200 is prevented from coming into contact with an object (including a guardrail, a curb, and the like) in which a position and a speed thereof have been input from the monitoring unit 210 to the travel controller 274.

The travel controller 274 stops the load-carrying vehicle 200 when acquiring a stop instruction from the management device 300. Instead of this, in a case in which the route information includes stop position information, the travel controller 274 may stop the load-carrying vehicle 200 when the positioning result of the GNSS receiver 216 and a stop position match. That is to say, a stop instruction or information regarding a stop position are provided from the management device 300 to the travel controller 274 and the travel controller 274 stops the load-carrying vehicle 200 in accordance with these. The position in which the load-carrying vehicle 200 is caused to stop includes a road surface. Particularly, when the user U will load the load P into the storage part 240 of the load-carrying vehicle 200, the load-carrying vehicle 200 stops on a road or in a parking lot.

The load-in/out controller 276 drives the indicator 232 and the opening/closing mechanism 236, for example, when receiving an instruction from the management device 300.

The airbag controller 278 causes the airbag 238 to inflate, for example, when the monitoring unit 210 detects that an object has collided with the load-carrying vehicle 200 or that an object is likely to collide with the load-carrying vehicle 200 and when the travel controller 274 causes a brake to suddenly operate (that is, due to sudden braking) to stop the load-carrying vehicle 200.

[Management Device]

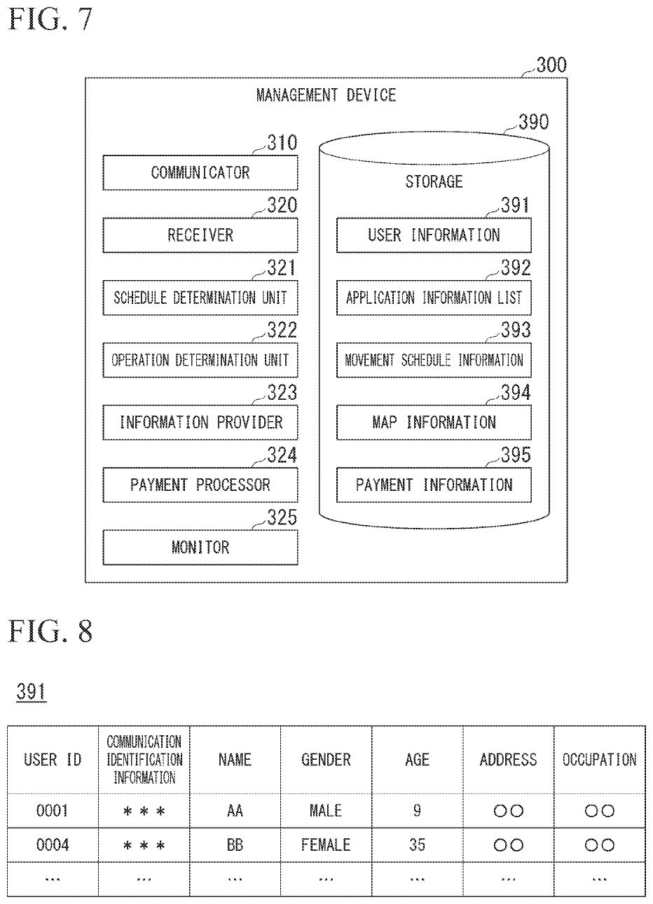

FIG. 7 is a diagram illustrating a constitution of the management device 300. The management device 300 includes, for example, a communicator 310, a receiver 320, a schedule determination unit 321, an operation determination unit 322, an information provider 323, a payment processor 324, and a monitor 325. These constituent elements are realized using, for example, a program (software) executed by a hardware processor, such as a CPU. Some or all of these constituent elements may be realized using hardware (circuits: including a circuitry), such as an LSI, an ASIC, an FPGA, and a GPU, or may be realized in cooperation with software and hardware. The program may be stored in advance in a storage device (a storage device including a non-transient storage medium), such as an HDD or a flash memory, may be stored in a removable storage medium (a non-transient storage medium), such as a DVD or a CD-ROM, and may be installed in a storage device when a storage medium is installed in a drive device. The management device 300 may include a storage 390. The storage 390 is realized using a DVD, a random-access memory (RAM), a flash memory, or the like. The storage 390 stores information, such as user information 391, an application information list 392, movement schedule information 393, map information 394, and payment information 395.

FIG. 8 is a diagram illustrating an example of the details of the user information 391. For example, the user information 391 is obtained by associating a user ID which is identification information of a user U with information, such as communication identification information, a name, a gender, an age, an address, and an occupation.

Each item of the user information 391 is registered in advance at the time of performing subscribing to a service (for example, the carrying service) managed by the management device 300. The communication identification information is information required for transmitting information to the terminal device 100 and is information, such as an application ID, an Internet protocol (IP) address, a media access control (MAC) address, and an email address, provided to an application program.

Referring to FIG. 7 again, the communicator 310 is, for example, a network card configured to perform connection to the network NW. The communicator 310 communicates with the terminal device 100 and the load-carrying vehicle 200 over the network NW.

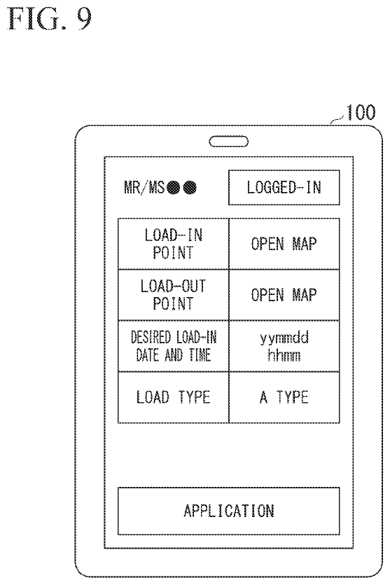

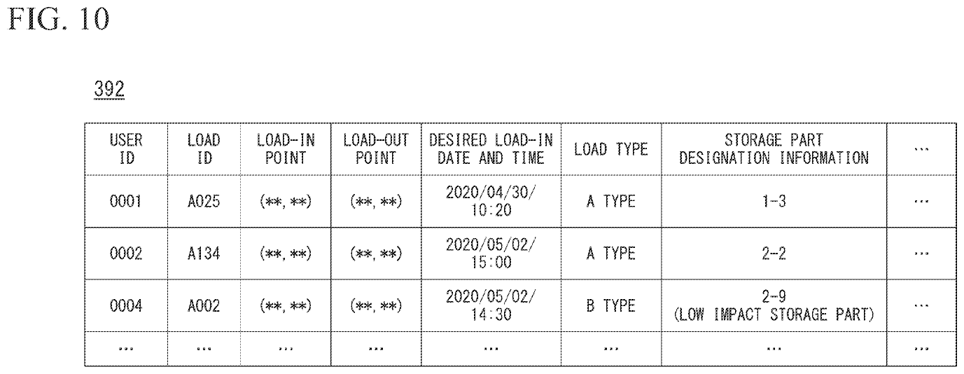

The receiver 320 acquires (receives) application information issued from the terminal device 100 of the user U and adds the application information to the application information list 392 via the communicator 310. FIG. 9 is a diagram illustrating an example of a carrying service application screen for an input of application information displayed on the display of the terminal device 100. As illustrated in FIG. 9, the carrying service application screen can receive, as an input, a load-in point, a load-out point, a desired load-in time, a load type indicating a size and a shape of a load, and the like and information input by the user U is transmitted to the management device 300 as application information on the carrying service application screen. The load-in point and the load-out point are input, for example, when the terminal device 100 displays a map and the user U designates a point on the map.

FIG. 10 is a diagram illustrating an example of the details of the application information list 392. The application information list 392 includes, for example, information in which a user ID of the user U who has sent application information, a load ID which is identification information of a load, a load-in point which is a start point and a load-out point which is an end point of a section relating to the carrying of the load, a desired load-in time, a load type, storage part designation information, and the like are associated with each other. A set of user ID, load ID, load-in point, load-out point, desired load-in time, and load type relating to one piece of application information is referred to as a “record”. The load ID is provided using the receiver 320. The application information is any form of information including the details required for generating one record. The storage part designation information is information indicating a determination of which the storage part 240 is assigned. In FIG. 10, “1” of “1-3” indicates any of the storage parts 240 opened on the upper surface side of the load-carrying vehicle 200 and “-3” indicates any of the nine storage parts on the upper surface side thereof.

Also, “2” of “2-2” indicates any of the storage parts 240 opened on the back surface side of the load-carrying vehicle 200 and “-2” indicates any of the nine storage parts on the back surface side thereof. Furthermore, “2-9” indicates that the storage part is the low impact storage part 242 (the storage part 240-9) of the storage parts 240 opened on the back surface side of the load-carrying vehicle 200.

Referring to FIG. 7 again, the schedule determination unit 321 decides the assignment of the storage part 240 into which the load P is stored among the plurality of storage parts 240 and generates storage part designation information. If deciding the storage part 240 to correspond to the application information received from the user U, the schedule determination unit 321 transmits storage part designation information indicating the decided storage part 240 to the terminal device 100 of the user U.

The terminal device 100 displays information indicating the decision details. Thus, the user U can recognize in advance a position of the storage part 240 into which the load P is to be stored.

Here, the schedule determination unit 321 assigns the low impact storage part 242 when, regarding a “load type” included in the application information received from the user U, a type of new load P to be collected is a type of load P (hereinafter referred to as a “load type B”), such as easily breakable articles, fragile articles, and soft articles required to be carried more carefully than other types of loads P (hereinafter referred to as a “load type A”). The load type B is an example of a “prescribed type”. Furthermore, the carrying of the load P by loading the load P into the low impact storage part 242 is an example of the “carrying of a new load collected in a manner in which the new load does not easily receive an influence from the outside compared with other types of loads”. Furthermore, the schedule determination unit 321 is an example of an “assignment determination unit” in a process of deciding the assignment of the storage part 240 for a “prescribed type” of load P. Thus, the schedule determination unit 321 can carry the load P in an appropriate manner in which the load P of the load type B is carried.

If a new application information record is added to the application information list 392, the schedule determination unit 321 selects the load-carrying vehicle 200 to be used for the user U associated with the application information from the plurality of load-carrying vehicles 200 with reference to a list (not shown) of the load-carrying vehicles 200 and the movement schedule information 393. For example, the schedule determination unit 321 narrows down the load-carrying vehicles 200 which can carry the load P with reference to the load type included in the application information, adds the collection of the load P to the existing movement schedule if the incorporation of the collection of the load P into the existing movement schedule of the load-carrying vehicle 200 incorporated in the movement schedule information 393 in advance is appropriate, and then sets a new movement schedule for the load-carrying vehicle 200 and registers the collection of the load P if the incorporation of the collection of the load P into the existing movement schedule of the load-carrying vehicle 200 incorporated in the movement schedule information 393 in advance is not appropriate. Moreover, the storage part designation information is decided as described above and is transmitted to the terminal device 100 of the user U.

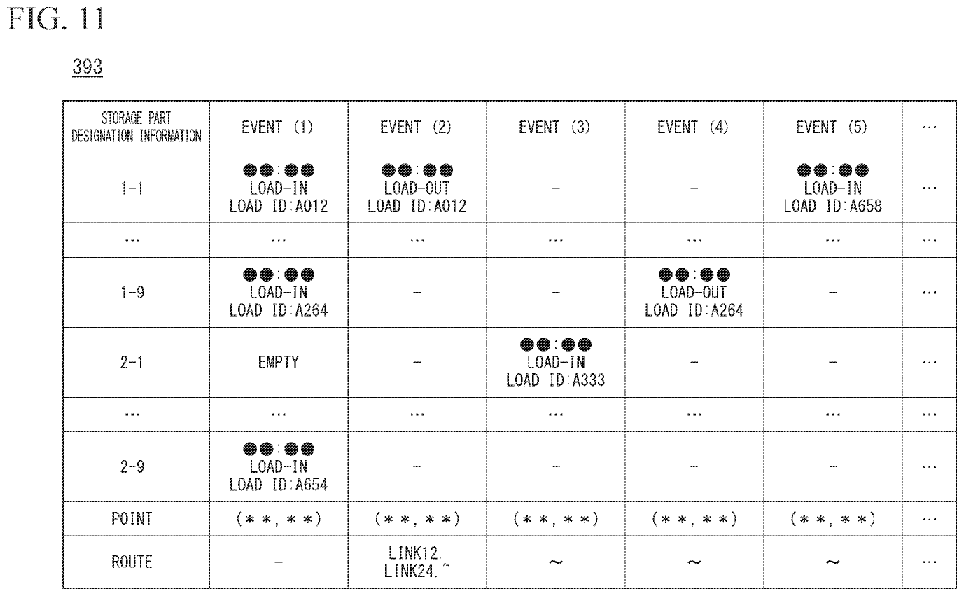

FIG. 11 is a diagram illustrating an example of the details of the movement schedule information 393. The movement schedule information 393 is set for each of the load-carrying vehicles 200 with a daily schedule as one unit. The movement schedule information 393 is obtained by associating, for each of the storage parts 240, an estimated time, information indicating loading-in or loading-out, a load ID of a load P to be carried, a point in which loading-in or loading-out is performed, route information between points (for example, it is assumed that the route is from a previous event to a current event), and the like with events in which carrying-in or carrying-out is performed (hereinafter referred to as a “load-in event or a load-out event” in some cases). The route is represented by, for example, sequentially arranging links in the map information 394. For example, the schedule determination unit 321 roughly groups the application information records for each date, time zone, and region, sets some movement patterns in which a plurality of load-in points and desired load-in times are arranged in order, extracts a movement pattern with the lowest movement cost with reference to the map information 394, and then adds the extracted movement pattern to the movement schedule information 393. With regard to a calculation method and an evaluation method for the movement cost, since various methods are known in the field of navigation systems, description thereof will be omitted.

The operation determination unit 322 transmits an operation instruction to the load-carrying vehicle 200 using the communicator 310 on the basis of the movement schedule information 393 as described above. That is to say, the operation determination unit 322 decides an operation of the load-carrying vehicle 200 on the basis of the movement schedule information 393 generated on the basis of the application information received by the receiver 320. The operation of the load-carrying vehicle 200 decided by the operation determination unit 322 includes details, such as a stop instruction at a route, a load-in point, or a load-out point (an instruction for a stop timing may be provided or an instruction of a point may be provided and may be left to the judgment of the load-carrying vehicle 200) and a determination of which the storage part 240 is caused to be empty at a load-in point or a load-out point.

As illustrated in FIG. 11, with regard to the storage part 240 in which the storage part designation information is “1-1,” the movement schedule information 393 is set so that a load P in which a load ID is “A012” is loaded-in at event (1), carried, and loaded-out at event (2), and then a load P in which a load ID is “A658” is loaded-in at event (5). Furthermore, with regard to the storage part 240 in which the storage part designation information is “2-1,” while a load P is being delivered using another storage part 240, a load P in which a load ID is “A333” is loaded-in at event (3). The operation determination unit 322 accordingly causes the load-carrying vehicle 200 which is in the process of delivering the load P to collect a new load P. Furthermore, the operation determination unit 322 instructs the opening/closing mechanism 236 which is a drive part of the door 230 so that a new load P to be collected is loaded into a storage part 240 which becomes empty due to the finished delivering of the load-carrying vehicle 200 which is in the process of delivering the load P. As a result, convenience can be improved.

Also, when the load P is the “load type B,” the operation determination unit 322 makes a decision so that the load-carrying vehicle 200 travels on a route in which the load P stored in the low impact storage part 242 does not easily receive an impact from the outside as compared with a carrying route when the load type A is carried. For example, the map information 394 further includes information indicating a road width, a state of the pavement of a road, a traffic volume, and the like associated with the road. In addition, when the load P is the “load type B,” the operation determination unit 322 decides a route by selecting a wide road or a road with good pavement conditions (less unevenness or step) while the load-carrying vehicle 200 passes through a load-in point or a load-out point. Thus, the operation determination unit 322 can make the load P stored in the low impact storage part 242 less likely to receive an impact from the outside and the carrying is possible in a manner suitable for the type of load P. “Causing the load-carrying vehicle 200 to travel on a route in which the stored load P does not easily receive an impact from the outside” is an example of a “manner in which the stored load P does not easily receive an influence of an impact from the outside”.

Also, when the load P is the “load type B,” the operation determination unit 322 decides that the load-carrying vehicle 200 is caused to travel at a speed lower than that in a carrying route when the load type A is carried. Thus, the operation determination unit 322 can make the load P stored in the low impact storage part 242 less likely to receive an impact from the outside, such as vibrations and a centrifugal force due to a curve and can carry the load P stored in the low impact storage part 242 in a manner suitable for the type of load P. “Causing the load-carrying vehicle 200 to travel at a lower speed” is an example of the “manner in which the stored load P does not easily receive an influence of an impact from the outside”.

Referring to FIG. 7 again, the information provider 323 causes the terminal device 100 of the user U to provide position information and route information of the load-carrying vehicle 200. The information provider 323 transmits the position information uploaded using the communication device 214 through the communication controller 272 of the load-carrying vehicle 200 and the route information described in the movement schedule information 393 to the terminal device 100 using the communicator 310. The information provider 323 transmits, for example, information used for displaying an image indicating position information and route information superimposed on a map image to the terminal device 100.

The payment processor 324 performs processing for collecting a fee from the user U. For example, the payment processor 324 collects a fee from the user U in cooperation with a credit card or an electronic money management server.

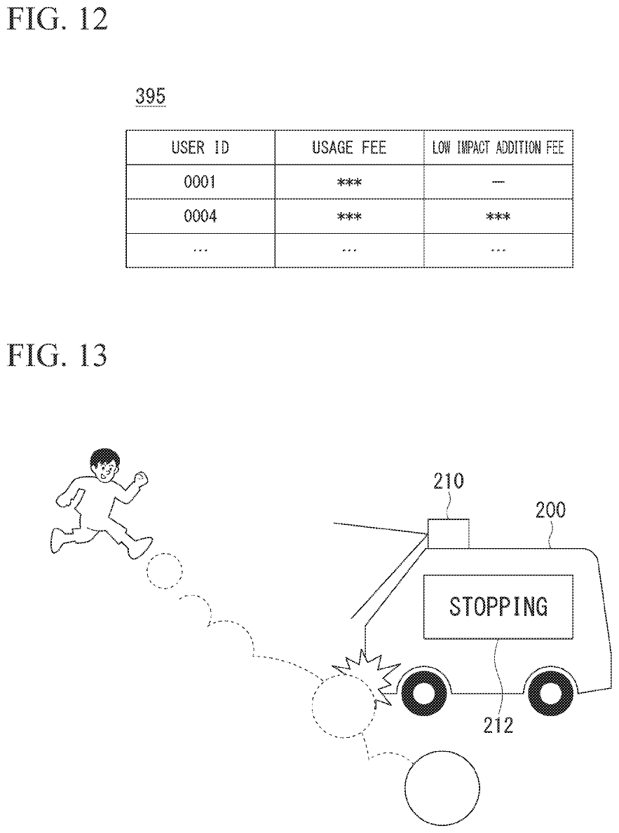

FIG. 12 is a diagram illustrating an example of the details of the payment information 395. The payment information 395 is, for example, obtained by associating a user ID, information indicating a usage fee for the carrying service, and information indicating the low impact addition fee with each other. The usage fee is a fee which is decided in advance through a fee regulation and the like of the carrying service and has different amounts of money in accordance with a size, a weight, a carrying distance, and the like of a load P. The low impact addition fee is, for example, a fee which is further added to a usage fee when the low impact storage part 242 is used for carrying a load P. The payment processor 324 calculates, for example, a usage fee associated with the use of the carrying service each time the user U uses the carrying service. Furthermore, the payment processor 324 further calculates the low impact addition fee when the low impact storage part 242 is used. Moreover, the payment processor 324 generates (updates) the payment information 395 by adding the calculated usage fee and low impact addition fee to the usage fee and the low impact addition fee associated with the corresponding user ID. The payment processor 324 collects a fee which includes the usage fee from the user U and the low impact addition fee with reference to the payment information 395. Therefore, when the low impact storage part 242 is used, the payment processor 324 collects, from the user U, a fee higher than that of when the low impact storage part 242 is not used.

The payment processor 324 may collect a fee from the user U each time the user U uses the carrying service with reference to the payment information 395 or may collectively collect, from the user U, a fee which includes the usage fee for the carrying service corresponding to a prescribed period for each prescribed period (for example, every month). In the following description, it is assumed that the payment processor 324 collects a fee which includes the usage fee for the carrying service for a prescribed period from the user U.

Referring to FIG. 7 again, the monitor 325 determines whether a prescribed event has occurred in the load-carrying vehicle 200. In addition, when it is determined that a prescribed event has occurred, the monitor 325 requests the operator OP to operate the load-carrying vehicle 200 and causes the load-carrying vehicle 200 to operate in accordance with the operation of the operator OP. The operator OP is a person associated with a providing subject who provides the carrying service and responds to inquiries from the management device 300 and the user U. The operator OP communicates with the terminal device 100 of the user U, the load-carrying vehicle 200, and the management device 300 using the operator device 400. The details of the processing of the monitor 325 will be described later.

### [Other Controls]

At a site in which the load-carrying vehicle 200 actually operates, the process may not be performed in accordance with the movement schedule information 393 in some cases. For example, it is assumed that a user U who is a receiver is absent at a load-out point in which the load P is delivered. At that time, when an attempt is performed to load another load into the storage part 240 which has been empty due to the finished delivery, actually, the load P is still in the storage part 240. Thus, it is assumed that the other load cannot be loaded-in.

In preparation for such a situation, the schedule determination unit 321 changes the movement schedule information 393 to change the originally decided route and move the load-carrying vehicle 200 for the purpose of delivery when the storage part 240 scheduled for the loading-in of the load P in the movement schedule information 393 is not empty due to the absence of the user U of a delivery destination of the stored load P and move the load-carrying vehicle 200 to the load-in point associated with the load-in schedule when any of the storage parts 240 becomes empty.

For the associated operation, the load-carrying vehicle 200 transmits an operation status of the door 230 at the load-in point and the load-out point to the management device 300. The schedule determination unit 321 judges that the load P has not been loaded out as scheduled on the basis of the information received from the load-carrying vehicle 200 and changes the movement schedule information 393, causes the load-carrying vehicle 200 to move to a point of an event associated with the next loading-out when the next event is a load-in event and there is no empty storage part 240, and causes the load-carrying vehicle 200 to move to the load-in point associated with the immediately previous load-in event and loads in the load P when the load P which has been moved has been loaded out as scheduled. The schedule determination unit 321 may transmit information to the terminal device 100 of the user U who is scheduled for the loading-in of the load P when a load-in time is delayed due to a change in the schedule and notify the user U of the information.

The schedule determination unit 321 may or may not add an event to the load-carrying vehicle 200 which has been subjected to departure in the movement schedule information 393. When an event is added to the load-carrying vehicle 200 which has been subjected to departure, in the movement schedule information 393 for a certain load-carrying vehicle 200, the schedule determination unit 321 may not add a schedule relating to collection after the departure of the load-carrying vehicle 200 when a new load is scheduled to be loaded into the storage part 240 which has become empty after the load P has been delivered. In this way, it is possible to reduce the possibility that the load P cannot be loaded in due to the absence of the user U who is a receiver.

### [Regarding Processing of Monitor 325]

The details of the processing of the monitor 325 will be described below. The monitor 325 determines whether a prescribed event has occurred in the load-carrying vehicle 200 on the basis of the detection result of the monitoring unit 210. The prescribed event includes, for example, that the traveling of the load-carrying vehicle 200 is impossible, that the detection of a current position of the load-carrying vehicle 200 is impossible, that the load-carrying vehicle 200 has collided (is likely to collide) with another object, and the like.

The monitor 325 determines that the traveling of the load-carrying vehicle 200 is impossible, for example, when the monitoring unit 210 detects that an object is hindering or has hindered the traveling of the load-carrying vehicle 200. The fact that an object is hindering or has hindered the traveling of the load-carrying vehicle 200 includes, for example, that an object is blocking (has blocked) a traveling path of the load-carrying vehicle 200, that a (malicious) person is standing (or has stood) in the traveling path of the load-carrying vehicle 200, that there is a construction site, a narrow road, a step, or the like in a direction in which the load-carrying vehicle 200 moves forward, and the like.

Also, the monitor 325 determines that the detection of a current position of the load-carrying vehicle 200 is impossible, for example, when the positioning result of the load-carrying vehicle 200 itself using the GNSS receiver 216 cannot be obtained, the positioning result of the GNSS receiver 216 obtained within a prescribed time is missing, or the positioning result of the GNSS receiver 216 obtained within a prescribed time indicates a position in which the load-carrying vehicle 200 cannot move within a prescribed period.

Furthermore, the monitor 325 determines that the load-carrying vehicle 200 has collided (is likely to collide) with another object, for example, when image recognition processing specifically performs the displaying of an object which collides (has collided) with the load-carrying vehicle 200 in an image showing the surroundings of the load-carrying vehicle 200 acquired using the monitoring unit 210 and when the monitor 325 detects that the load-carrying vehicle 200 has been impacted.

The travel controller 274 stops the traveling of the load-carrying vehicle 200 when the monitoring unit 210 detects that a prescribed event has occurred in the load-carrying vehicle 200. At this time, the control device 270 may cause an image indicating that the load-carrying vehicle 200 is stopped to be displayed on the display device 212. The monitor 325 requests the operator OP to operate the load-carrying vehicle 200 when it is determined that a prescribed event has occurred. To be specific, the monitor 325 causes the operator device 400 to transmit information requesting an operation of the load-carrying vehicle 200 using the communicator 310 over the network NW.

The operator OP accesses the monitoring unit 210 of the load-carrying vehicle 200 over the network NW when receiving a request for an operation of the load-carrying vehicle 200 from the management device 300 via the operator device 400 and grasps a situation of the load-carrying vehicle 200 with reference to the detection result of the monitoring unit 210. Moreover, the operator OP inputs an operation for selecting an option of a subsequent operation of the load-carrying vehicle 200 to the operator device 400. The option of the operation includes, for example, that the load-carrying vehicle 200 is caused to slowly move to a safe place (option 1), that the load-carrying vehicle 200 is caused to move to the next point (a load-in point or a load-out point) by starting the operation again (option 2), that the operator OP controls the operation of the load-carrying vehicle 200 on the basis of the detection result of the monitoring unit 210 (option 3), that the operation of the load-carrying vehicle 200 is requested from a user U who exists around the load-carrying vehicle 200 (option 4), that the measures to resolve a prescribed event which has occurred in the load-carrying vehicle 200 are requested from a user U who exists around the load-carrying vehicle 200 (option 5), and the like. The operator device 400 transmits information indicating an operation of the operator OP to the management device 300.

### (When Option 1 has Been Selected)

The operator OP selects option 1, for example, when the load-carrying vehicle 200 has collided with an object, in which the load-carrying vehicle 200 can be caused to move if a travel distance is a short distance and the collided object does not interfere with the traveling of the load-carrying vehicle 200. The monitor 325 of the management device 300 receives information indicating an option from the operator device 400. When the received information indicates option 1, the monitor 325 causes the load-carrying vehicle 200 to be instructed using the operation determination unit 322 so that the load-carrying vehicle 200 slowly moves to a safe place.

The control device 270 specifically identifies a safe place, such as a road shoulder or a roadside band around the load-carrying vehicle 200 on the basis of the detection result of the monitoring unit 210 in response to an instruction of the operation determination unit 322. Moreover, the control device 270 causes the load-carrying vehicle 200 to slowly move to the specifically identified safe place.

Thus, the monitor 325 can cause the load-carrying vehicle 200 to safely stop even when a prescribed event has occurred in the load-carrying vehicle 200.

### (When Option 2 has Been Selected)

FIG. 13 is a diagram illustrating an example of a scene in which option 2 is selected. The operator OP selects option 2, for example, when the load-carrying vehicle 200 has collided with an object, in which there is no problem when the load-carrying vehicle 200 travels and the collided object does not interfere with the traveling of the load-carrying vehicle 200. An example of a collision in which there is no problem when the load-carrying vehicle 200 travels and the collided object does not interfere with the traveling of the load-carrying vehicle 200 is when a ball collides with the load-carrying vehicle 200 and the ball has already been removed (refer to FIG. 13).

When the received information indicates option 2, the monitor 325 causes the load-carrying vehicle 200 to be instructed using the operation determination unit 322 so that the load-carrying vehicle 200 is caused to move to the next scheduled point. The control device 270 starts the operation again in accordance with the movement schedule information 393 in response to an instruction of the operation determination unit 322 and causes the load-carrying vehicle 200 to move to the next scheduled point. Thus, the monitor 325 can continuously perform the carrying service using the load-carrying vehicle 200 even when a prescribed event has occurred in the load-carrying vehicle 200.

### (When Option 3 has Been Selected)

The operator OP selects option 3, for example, when the load-carrying vehicle 200 has collided with an object, in which there is no problem when the load-carrying vehicle 200 travels and the operator OP wants to move (travel) the load-carrying vehicle 200 to a desired place. The monitor 325 of the management device 300 receives information indicating an option from the operator device 400. When the received information is option 3, the monitor 325 causes the load-carrying vehicle 200 to be instructed using the operation determination unit 322 so that the control device 270 and the operator device 400 are caused to communicate with each other, the operator device 400 is caused to transmit the detection result of the monitoring unit 210, and the control device 270 is caused to transmit information indicating a control operation of the operator OP. Thus, the monitor 325 can move the load-carrying vehicle 200 to a position desired by the operator OP even when a prescribed event has occurred in the load-carrying vehicle 200.

### (When Option 4 or Option 5 has Been Selected)

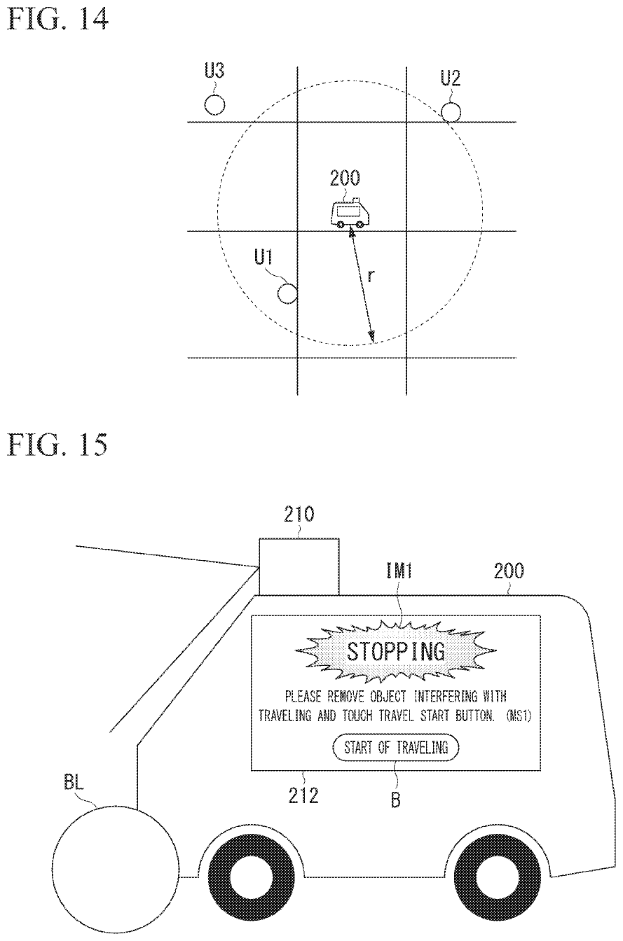

FIG. 14 is a diagram illustrating an example of a scene in which option 4 is selected. For example, the operator OP selects option 4 when the load-carrying vehicle 200 has collided with an object and there is an object which interferes with the traveling of the load-carrying vehicle 200 and selects option 5 when the load-carrying vehicle 200 has collided with an object and the operator OP cannot judge whether there is a problem when the load-carrying vehicle 200 travels. When the received information indicates option 4 or option 5, the monitor 325 causes the information provider 323 to provide request information for requesting the operation of the load-carrying vehicle 200 from the user U to the terminal device 100 of a user U who exists around the load-carrying vehicle 200. The user U who requests the operation of the load-carrying vehicle 200 is a user U (a user U1 in FIG. 14) in which the terminal device 100 of the user U exists within a prescribed distance r from the load-carrying vehicle 200. For example, the information provider 323 acquires information indicating a position of the terminal device 100 from the terminal device 100 over the network NW and provides request information to the terminal device 100 in which the position of the terminal device 100 is within the prescribed distance r from the load-carrying vehicle 200. The request information includes, for example, information indicating a position of the load-carrying vehicle 200, a route from a position of a user U to the load-carrying vehicle 200, a state of the load-carrying vehicle 200, an operation of the load-carrying vehicle 200 requested from a user U, and the like.

FIG. 15 is a diagram illustrating an example of the state of the load-carrying vehicle 200 when option 4 has been selected. The load-carrying vehicle 200 stops its traveling when the load-carrying vehicle 200 has collided with an object and there is an object which interferes with the traveling of the load-carrying vehicle 200. Furthermore, at this time, on the basis of an instruction of the monitor 325, the control device 270 causes an image IM1 showing that the load-carrying vehicle 200 is stopped, a message MS1 for explaining an operation to be performed on the load-carrying vehicle 200 by a user U, a traveling start button B, and the like to be displayed on the display device 212. The message MS1 is a message, such as the expression “please remove an object which is hindering the traveling and touch the traveling start button”.

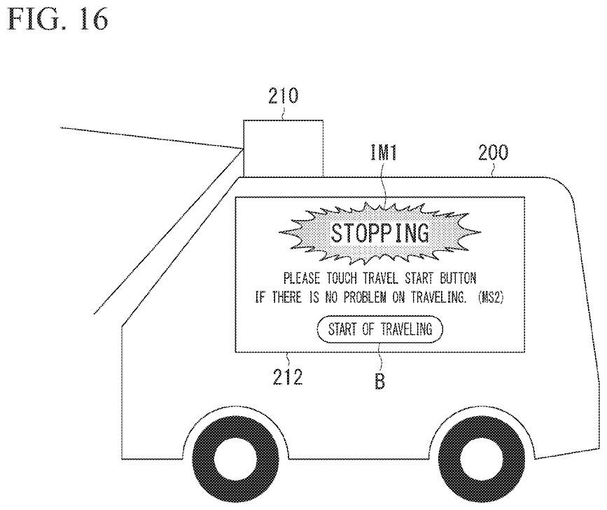

FIG. 16 is a diagram illustrating an example of a state of the load-carrying vehicle 200 when option 5 has been selected. The load-carrying vehicle 200 stops its traveling when the load-carrying vehicle 200 has collided with an object and the operator OP cannot judge whether there is a problem when the load-carrying vehicle 200 travels.

Also, at this time, on the basis of an instruction of the monitor 325, the control device 270 causes an image IM2 showing that the load-carrying vehicle 200 is stopped, a message MS2 for explaining an operation to be performed on the load-carrying vehicle 200 by a user U, the traveling start button B, and the like to be displayed on the display device 212. The message MS2 is a message, such as the expression “please touch the traveling start button, if there is no problem when the load-carrying vehicle 200 travels”.

The user U of the terminal device 100 which has received request information moves to the position of the load-carrying vehicle 200 and operates the load-carrying vehicle 200. In this case, the user U checks the surroundings of the load-carrying vehicle 200, removes any obstacle (the ball BL in FIG. 16) if there is an obstacle, and touches the traveling start button B if there is no problem when the load-carrying vehicle 200 travels. The control device 270 causes the operation to start again according to the movement schedule information 393 when the traveling start button B has been operated and causes the load-carrying vehicle 200 to move to the next scheduled point. Thus, the monitor 325 can cause the carrying service using the load-carrying vehicle 200 to continuously be performed even when a prescribed event has occurred in the load-carrying vehicle 200.

Although a case in which the operation of the load-carrying vehicle 200 requested from the user U is an operation in which the user U touches the traveling start button B has been described in the above description, the present invention is not limited thereto. The operation of the load-carrying vehicle 200 requested from the user U may be, for example, the driving of the load-carrying vehicle 200.

In this case, the information provider 323 transmits request information for requesting the driving of the load-carrying vehicle 200 from the user U to the terminal device 100.

### [Regarding Incentive]

When the user U has responded in association with the load-carrying vehicle 200 in accordance with the request information, the payment processor 324 provides an incentive to the user U. In this case, the communication controller 272 communicates with the terminal device 100 of the user U which has been subjected to the operation of the traveling start button B and acquires a user ID of the user U. The communication controller 272 transmits the acquired user ID and information indicating that the user U corresponding to the user ID has responded to the request of the request information to the management device 300. The payment processor 324 provides an incentive to the user U on the basis of the information received from the control device 270. In this case, the payment processor 324 searches for the payment information 395 using the received user ID as a search key and a new usage fee is obtained by subtracting a fee corresponding to the incentive from a usage fee (or a low impact addition fee or a total fee of a usage fee and a low impact addition fee) associated with the same user ID. Thus, the payment processor 324 can reduce the usage fee by providing an incentive to the user U who has responded in association with the load-carrying vehicle 200 in accordance with the request information.

### [Operation Flow]

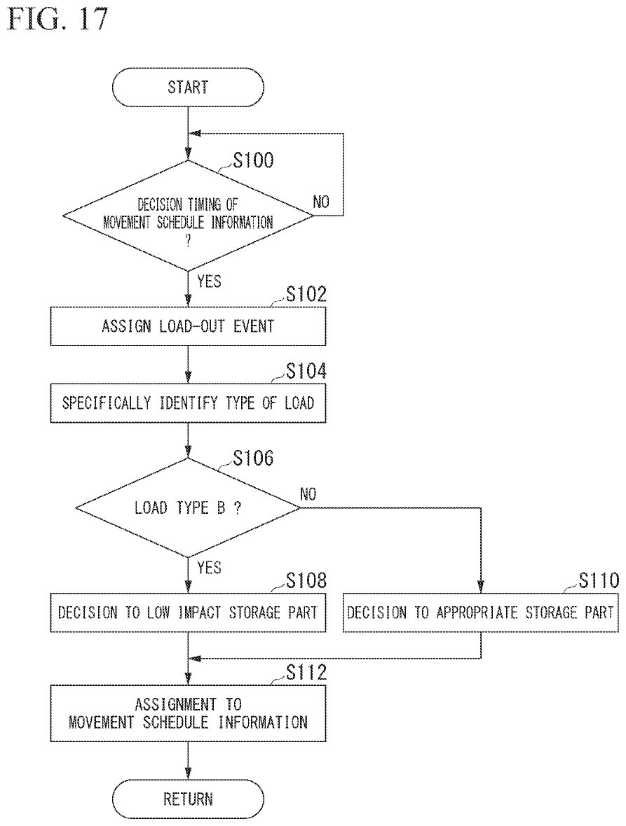

FIG. 17 is a flowchart describing an example of processing of assigning the low impact storage part 242.

First, the management device 300 determines whether a timing has reached a decision timing of the movement schedule information 393 (Step S100). The decision timing of the movement schedule information 393 may be a timing at which a timing reaches the timing periodically or a timing at which a timing reaches the timing every time the application information is received in a prescribed time zone. In this flowchart, for the sake of simple explanation, for example, it is assumed that a timing reaches the timing once a day.

If the timing has reached the decision timing of the movement schedule information 393, the schedule determination unit 321 first assigns a load-out event to the movement schedule information 393 (Step S102).

Subsequently, the schedule determination unit 321 specifically identifies a type of new load P to be collected from the application information (Step S104). The schedule determination unit 321 determines whether the type of specifically identified load P is a type of load P which is required to be carefully carried (that is, the “load type B”) (Step S106). The schedule determination unit 321 decides that the storage part 240 in which the load P is stored is set to the low impact storage part 242 when it is determined that the type of load P is the load type B (Step S108). The schedule determination unit 321 decides, as the storage part 240 in which the load P is stored, an appropriate storage part 240 among the storage parts 240 which can be used when it is determined that the type of load P is not the load type B (the load type A) (Step S110). Moreover, the schedule determination unit 321 extracts a load-in point and a desired load-in time (that is, the original information of a load-in event) from the application information and assigns the load-in event to the movement schedule information 393 together with the information of the decided storage part 240 (Step S112). The processes of Steps S102 to S112 are appropriately and repeatedly performed in accordance with the number of application information records.

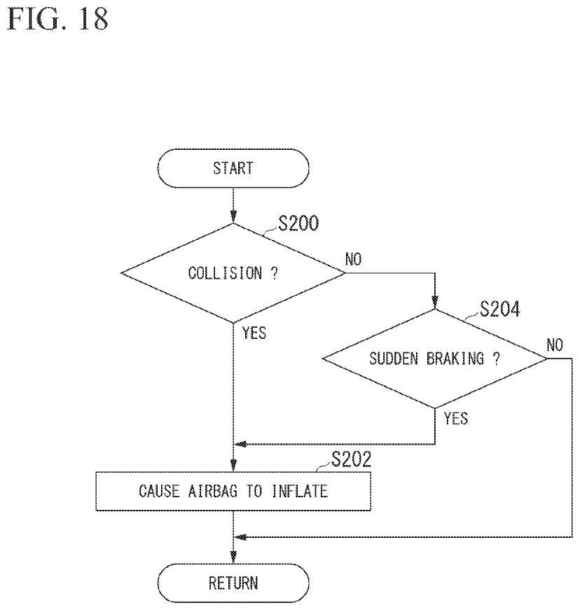

FIG. 18 is a flowchart describing an example of processing of the airbag controller 278. The airbag controller 278 determines whether the load-carrying vehicle 200 has collided (is likely to collide) with another object on the basis of the detection result of the monitoring unit 210 (Step S200). The airbag controller 278 causes the airbag 238 to inflate when it is determined that the load-carrying vehicle 200 has collided (is likely to collide) with the other object (Step S202). Furthermore, the airbag controller 278 determines whether the travel controller 274 has caused the load-carrying vehicle 200 to stop due to sudden braking based on the fact that the traveling of the load-carrying vehicle 200 is impossible and the fact that the detection of the current position of the load-carrying vehicle 200 is impossible when it is determined that the load-carrying vehicle 200 does not collide (is unlikely to collide) with another object (Step S204). The airbag controller 278 causes the airbag 238 to inflate when it is determined that the travel controller 274 has caused the load-carrying vehicle 200 to stop due to the sudden braking (Step S202).

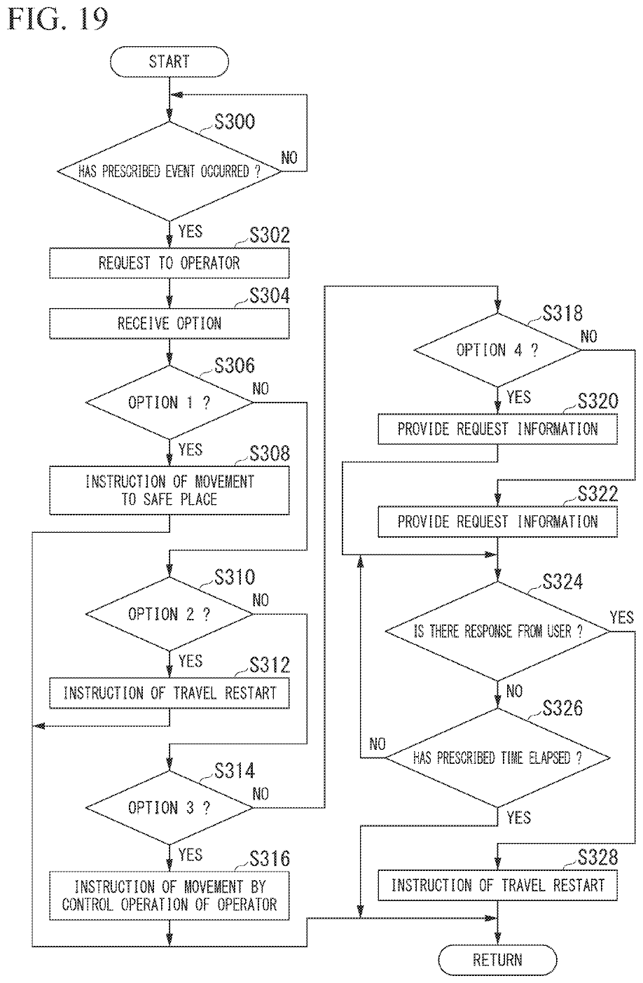

FIG. 19 is a flowchart describing an example of processing of the monitor 325. The monitor 325 determines whether a prescribed event has occurred in the load-carrying vehicle 200 on the basis of the detection result of the monitoring unit 210 (Step S300). The prescribed event includes, for example, that the traveling of the load-carrying vehicle 200 is impossible, that the detection of the current position of the load-carrying vehicle 200 is impossible, that the load-carrying vehicle 200 has collided (is likely to collide) with another object, and the like. The monitoring unit 210 waits until it is determined that a prescribed event has occurred. The monitor 325 requests the operation of the load-carrying vehicle 200 from the operator OP when it is determined that a prescribed event has occurred in the load-carrying vehicle 200 (Step S302).

The operator OP accesses the monitoring unit 210 of the load-carrying vehicle 200 over the network NW when receiving a request of the operation of the load-carrying vehicle 200 from the management device 300 via the operator device 400 and refers to the detection result of the monitoring unit 210. Moreover, the operator OP inputs an operation of selecting an option of a subsequent operation of the load-carrying vehicle 200 to the operator device 400. The option of the operation includes, for example, that the load-carrying vehicle 200 is caused to slowly move to a safe place (option 1), that the load-carrying vehicle 200 is caused to move to the next scheduled point by starting the operation again (option 2), that the operator OP controls the operation of the load-carrying vehicle 200 on the basis of the detection result of the monitoring unit 210 (option 3), that the operation of the load-carrying vehicle 200 is requested from a user U who exists around the load-carrying vehicle 200 (option 4), that the measures to resolve a prescribed event which has occurred in the load-carrying vehicle 200 are requested from a user U who exists around the load-carrying vehicle 200 (option 5), and the like. The operator device 400 transmits information indicating an operation of the operator OP to the management device 300.

The communicator 310 receives information indicating an option from the operator device 400 (Step S304). The monitor 325 determines whether the option received using the communicator 310 is to cause the load-carrying vehicle 200 to slowly move to a safe place (option 1) (Step S306). When it is determined that the option is (option 1), the monitor 325 causes the load-carrying vehicle 200 to be instructed using the operation determination unit 322 so that the load-carrying vehicle 200 slowly moves to the safe place (Step S308). When it is determined that the option is not (option 1), the monitor 325 determines whether the option is to cause the operation to start again and cause the load-carrying vehicle 200 to move to the next scheduled point (option 2) (Step S310). When it is determined that the option is (option 2), the monitor 325 causes the carrying service to start again and causes the load-carrying vehicle 200 to be instructed using the operation determination unit 322 so that the load-carrying vehicle 200 is caused to move to the next scheduled point (Step S312).

When it is determined that the option is not (option 2), the monitor 325 determines whether the option is that the operator OP controls the operation of the load-carrying vehicle 200 on the basis of the detection result of the monitoring unit 210 (option 3) (Step S314). When it is determined that the option is (option 3), the monitor 325 causes the control device 270 and the operator device 400 to communicate with each other, causes the operator device 400 to transmit the detection result of the monitoring unit 210, and causes the load-carrying vehicle 200 to be instructed using the operation determination unit 322 so that the control device 270 is caused to transmit information indicating a control operation of the operator OP (Step S316).

When it is determined that the option is not (option 3), the monitor 325 determines whether the option is that the operation of the load-carrying vehicle 200 is requested from a user U who exists around the load-carrying vehicle 200 (option 4) (Step S318). When it is determined that the option is (option 4), the monitor 325 causes the information provider 323 to provide, to the terminal device 100 of a user U who exists around the load-carrying vehicle 200, the request information in which the user U is requested to operate the load-carrying vehicle 200 and which requests the removal of an object that interferes with the traveling of the load-carrying vehicle 200 and the touching of the traveling start button by the user U (Step S320). Furthermore, when it is determined that the option is not (option 4), the monitor 325 regards that the operator OP has selected (option 5) and causes the information provider 323 to provide, to the terminal device 100 of a user U who exists around the load-carrying vehicle 200, the request information in which the operation of the load-carrying vehicle 200 is requested from the user U and the touching of the traveling start button is requested from the user U if there is no problem when the load-carrying vehicle 200 travels (Step S322).

The request information includes, for example, information indicating a position of the load-carrying vehicle 200, a route from a position of a user U to the load-carrying vehicle 200, a state of the load-carrying vehicle 200, an operation of the load-carrying vehicle 200 requested from a user U, and the like. The user U from which the operation of the load-carrying vehicle 200 is requested is a user U in which the terminal device 100 of the user U exists within a prescribed distance r from the load-carrying vehicle 200. In Steps S320 and S322, for example, the information provider 323 acquires information indicating a position of the terminal device 100 from the terminal device 100 over the network NW and provides the request information to the terminal device 100 in which the position of the terminal device 100 exists within the prescribed distance r from the load-carrying vehicle 200.

The operation determination unit 322 determines whether the user U who has provided the request information has operated the load-carrying vehicle 200 (Step S324). For example, the operation determination unit 322 acquires information indicating an input to an operation target of a user U (in this example, a touch panel of the display device 212) shown in the request information over the network NW and determines whether the user U has performed an operation. The operation determination unit 322 determines whether the user U has performed an operation until a prescribed time has elapsed after the request information has been provided (Step S326).

The operation determination unit 322 ends the process when the user U has not performed an operation until a prescribed time has elapsed after the request information has been provided. In this case, the monitor 325 may perform the process of Step S320 or S322 by resetting the prescribed distance r to a longer distance again or may instruct a person in charge who is a providing subject who provides the carrying service to go to the load-carrying vehicle 200. When the user U has performed an operation until a prescribed time has elapsed after the request information has been provided, the monitor 325 causes the carrying service to start again in accordance with the operation and causes the load-carrying vehicle 200 to be instructed using the operation determination unit 322 so that the load-carrying vehicle 200 is caused to move to the next scheduled point (Step S328).

### [Summary of Embodiment]

As described above, the management device 300 in this embodiment is the management device 300 which manages an operation of the load-carrying vehicle 200 which autonomously travels on a road with no driver on board and in which each of the plurality of storage parts 240 shielded using the door 230 which is opened and closed can store a load P includes: the operation determination unit 322 configured to decide an operation of the load-carrying vehicle 200; and the assignment determination unit (in this example, the schedule determination unit 321) configured to decide the assignment of the load P to any of the plurality of storage parts 240, in which, when the type of new load P to be collected is a prescribed type (in this example, the “load type B”), the schedule determination unit 321 makes a decision so that the new load P to be collected is caused to be carried in the manner in which the load cannot easily receive an influence from the outside as compared with other types of loads (in this example, the “load type A”). Thus, the management device 300 in this embodiment can cause the load to be carried in a manner suitable for the type of load.

Also, as described above, the management device 300 in this embodiment includes: the operation determination unit 322 configured to decide an operation of the load-carrying vehicle 200; and the monitor 325 configured to determine whether a prescribed event has occurred in the load-carrying vehicle 200, request the operation of the load-carrying vehicle 200 from an operator OP when it is determined that the prescribed event has occurred, and cause the load-carrying vehicle 200 to operate in accordance with the operation of the operator OP. Thus, the management device 300 in this embodiment can cause the load-carrying vehicle 200 to operate appropriately.

The embodiment described above can be expressed as follows.

A management device which manages an operation of a load-carrying vehicle which autonomously travels on a road with no driver on board and in which each of a plurality of storage parts shielded using a door which is opened and closed can store a load includes:

a storage device configured to store a program; and

a hardware processor,

in which the program executed by the hardware processor

decides an operation of the load-carrying vehicle,

decides assignment of the load to any of the plurality of storage parts, and

makes, when a type of new load to be collected is a prescribed type, a decision so that the new load to be collected is caused to be carried in a manner in which the load does not easily receive an influence from the outside as compared with other types of loads.

Also, the embodiment described above can be expressed as follows.

A management device which manages an operation of a load-carrying vehicle which autonomously travels on a road with no driver on board and in which each of a plurality of storage parts shielded using a door which is opened and closed can store a load includes:

a storage device configured to store a program; and

a hardware processor,

in which the program executed by the hardware processor

decides an operation of the load-carrying vehicle,

determines whether a prescribed event has occurred in the load-carrying vehicle, and

requests an operation of the load-carrying vehicle from an operator when it is determined that the prescribed event has occurred and causes the load-carrying vehicle to operate in accordance with the operation of the operator.

Although the aspects for carrying out the present invention have been described above using the embodiments, the present invention is not limited to these embodiments and various modifications and substitutions are provided without departing from the gist of the present invention.

What is claimed is:

1. A management device which manages an operation of a load-carrying vehicle which autonomously travels on a road with no driver on board and in which each of a plurality of storage parts shielded using a door which is opened and closed is able to store a load, the management device comprising:
an operation determination unit configured to decide an operation of the load-carrying vehicle; and
an assignment determination unit configured to decide assignment of the load to any of the plurality of storage parts,
wherein, when a type of new load to be collected is a prescribed type, the assignment determination unit makes a decision so that the new load to be collected is caused to be carried in a manner in which the load does not easily receive an influence from outside as compared with other types of loads.

2. The management device according to claim 1,
wherein, when the type of new load to be collected is a prescribed type, the assignment determination unit makes a decision so that a low impact storage part of the plurality of storage parts in which a load to be stored does not easily receive an influence of an impact from outside as compared with other storage parts stores the load, and
the operation determination unit instructs a drive part of the door corresponding to the low impact storage part decided using the assignment determination unit to load the new load to be collected.

3. The management device according to claim 2,
wherein the low impact storage part is a storage part provided at a center of the plurality of storage parts.

4. The management device according to claim 2,
wherein a suspension configured to reduce an influence of an impact from outside on a load to be stored is provided outside the low impact storage part.

5. The management device according to claim 2,
wherein a cushioning material configured to reduce an influence of an impact from outside on a load to be stored is provided inside the low impact storage part.

6. The management device according to claim 1,
wherein, when the type of new load to be collected is a prescribed type, the operation determination unit makes a decision so that the load-carrying vehicle is caused to travel on a route in which the load to be stored does not easily receive an influence of an impact from outside as compared with other carrying routes.

7. The management device according to claim 1,
wherein, when the type of new load to be collected is a prescribed type, the operation determination unit makes a decision so that the load-carrying vehicle is caused to travel at a speed lower than that in a case in which other types of loads are carried.

8. The management device according to claim 1, further comprising:
a payment processor configured to perform processing of collecting a usage fee from a user of a load-carrying service in which the load-carrying vehicle is used,
wherein, when a decision has been made so that the new load to be collected is caused to be carried in a manner in which the load does not easily receive an influence of an impact from outside, the payment processor collects a usage fee higher than that in a case in which a decision has been made so that the new load to be collected is caused to be carried in a manner other than a manner in which the new load to be collected does not easily receive an influence from outside.

9. The management device according to claim 1,
wherein a cushioning material configured to reduce an influence of an impact from outside on a load to be stored is provided on a side surface of each of the plurality of storage parts.

10. A management method in which a computer for a management device which manages an operation of a load-carrying vehicle which autonomously travels on a road with no driver on board and in which each of a plurality of storage parts shielded using a door which is opened and closed is able to store a load is utilized, the management method comprising:
deciding an operation of the load-carrying vehicle;
deciding assignment of the load to any of the plurality of storage parts; and
making, when a type of new load to be collected is a prescribed type, a decision so that the new load to be collected is caused to be carried in a manner in which the new load to be collected does not easily receive an influence from outside as compared with other types of loads.

11. A computer-readable non-transitory medium which includes a program causing
a computer for a management device which manages an operation of a load-carrying vehicle which autonomously travels on a road with no driver on board and in which each of a plurality of storage parts shielded using a door which is opened and closed is able to store a load:
to decide an operation of the load-carrying vehicle;
to decide assignment of the load to any of the plurality of storage parts; and
to make, when a type of new load to be collected is a prescribed type, a decision so that the new load to be collected is caused to be carried in a manner in which the new load to be collected does not easily receive an influence from outside as compared with other types of loads.
